(19) United States
(12) Patent Application Publication
(10) Pub. No.: US 2011/0082783 A1
(43) Pub. Date: Apr. 7, 2011

(54) EXCHANGE TRADED AND MANAGED SOVEREIGN DEBT

(76) Inventor: David Boberski, Westport, CT (US)

(21) Appl. No.: 12/573,254

(22) Filed: Oct. 5, 2009

(51) Int. Cl. G06Q 40/00

(52) U.S. Cl. 705/37

(57) ABSTRACT

A method of trading sovereign debt on an electronic trading exchange is disclosed. The method includes receiving financial parameters associated with a plurality of debt instruments offered by a sovereign entity, wherein the financial parameters include at least a maturity, a coupon and a rating, organizing the plurality of debt instruments according to their maturity and rating to define one or more debt instrument groups, defining a standardized financial product associated with each coupon in the one or more debt instrument groups, listing each standardized financial product on the an electronic trading exchange, and matching at least one of the standardized financial products with an order received at the electronic trading exchange.

### CROSS-REFERENCE TO RELATED APPLICATIONS

This patent document relates to co-pending U.S. patent application Ser. No. 12/021,568, titled “Standardization of Management of Over-the-Counter Financial Instruments,” filed on Jan. 29, 2008, the content of which is incorporated herein for all purposes.

### TECHNICAL FIELD

The present invention generally relates to software, systems and methods for electronic trading in a commodities exchange, derivatives exchange or similar business involving tradable items, and more particularly to software, systems and methods for electronic trading in a commodities exchange, derivatives exchange or similar business involving sovereign debt and/or sovereign debt instruments.

### BACKGROUND

Bonds are well-known debt securities that obligate the bond issuer to pay the bondholder. Typically, the bond issuer pays the bondholder interest payments, also referred to as coupons, according to a certain set schedule. The coupon payments are further accompanied by a lump sum repayment of the bond principle at a future date also referred to as the bond maturity or maturity. Thus, bonds are formal contracts to repay borrowed money with interest at fixed intervals.

Bonds are typically offered or issued by local, state and federal entities as a means of securing funds to finance, for example, investments and/or current financial expenditures. The most common process of issuing bonds is through underwriting. Underwriting involves analyzing each bond offering and the risk associated with each bond offering. Individuals bonds and/or groups or bundles of bonds may be sold to investors according to the risk. Government or sovereign bonds or debt are often sold, or resold, via a bond auction.

### SUMMARY

In one embodiment, a method of trading sovereign debt on an electronic trading exchange is disclosed. The method includes receiving financial parameters associated with a plurality of debt instruments offered by a sovereign entity, wherein the financial parameters include at least a maturity, a coupon and a rating, organizing the plurality of debt instruments according to their maturity and rating to define one or more debt instrument groups, defining a standardized financial product associated with each coupon in the one or more debt instrument groups, listing each standardized financial product on the an electronic trading exchange, and matching at least one of the standardized financial products with an order received at the electronic trading exchange.

In another embodiment, a method of trading sovereign debt on an electronic trading exchange is disclosed. The method includes receiving a first order for a standardized financial product, wherein the standardized financial product is based on at least two sovereign debt instruments, and wherein the at least two debt instruments are organized based on a maturity and a coupon, receiving a second order for the standardized financial product, matching the first order and the second order with the standardized financial instrument, executing a trade based on the matched first and second orders, wherein the first order represents a long position in the standardized financial product and the second order represents a short position in the standardized financial product, and outputting the trade from the electronic trading exchange.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 illustrates an electronic trading system.

FIG. 2 illustrates a detailed view of a contract generator of the electronic trading system of FIG. 1;

FIG. 3 illustrates an exemplary bond offering;

FIG. 4 illustrates an exemplary bond offering according to the disclosure presented herein;

FIG. 5 illustrates an exemplary process for trading sovereign debt instruments in the electronic trading system shown in FIG. 1.

### DETAILED DESCRIPTION

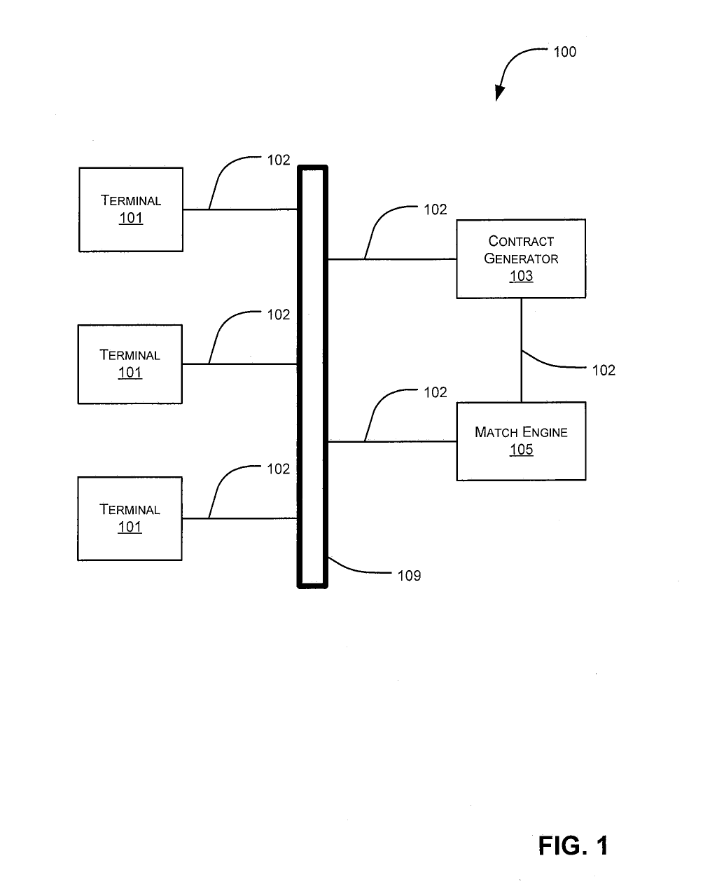

FIG. 1 illustrates an electronic trading system 100 including a plurality of terminals 101, a plurality of communication links 102, a bus 109, a contract generator 103, and a match engine 105. The contract generator 103 and match engine 105 are coupled with each other as well as terminals 101 via the plurality of communication links 102 and the bus 109. As used herein, the phrase “coupled with” is defined to mean directly connected to or indirectly connected through one or more intermediate components. Such intermediate components may include both hardware and software based components.

The communication link 102 connects the terminals 101, contract generator 103, and match engine 105 over any sized geographical area. In one embodiment, the communication link 102 includes a network such as a local area network (“LAN”), a wide area network (“WAN”), a metropolitan area network, a virtual area network, a wireless local network, a local bus, a direct or indirect satellite network, or combinations thereof. Further, the communications link 102 may include a publicly accessible network such as the Internet, a privately accessible network such as an Intranet, or a combination of privately and publicly accessible networks. In one embodiment, the communication link 102 includes a data conversion device, such as a modem, that converts data from one form into another, e.g. converts data from one form usable with electronic equipment to another form useable over wireless or landline communication technologies. Such conversion devices include conventional modems that can be used with the public switched telephone network, cellular modems and other network interface devices. Preferably, the communication link 102 provides a high-bandwidth data communication link that achieves high transmission speeds and low latency. Further, the communications link 102 may utilize secure protocols, such as secure-Hypertext Transfer Protocol (“HTTP”), pretty good privacy (“PGP”), etc., to ensure that communications among the devices coupled with the link 102 are authorized, authentic and/or otherwise uncompromised.

Preferably, terminal 101 includes a memory, an interface, a processor, and operating firmware/software that perform functions, such as receiving input from a user, generating and transmitting instructions to contract generator 103 to generate, for example, a futures contract based on a standardized and/or commoditized sovereign debt instrument and receiving a response to those instructions. Terminal 101 may be a conventional computer, a hybrid personal computer, a personal digital assistant (PDA), a laptop computer, a mobile telephone or any other device that can receive and send information through a communication link. Terminal 101 may also include a display device, a keyboard, a mouse, a touch panel, a graphical user interface (GUI), a printer, a scanner, and/or other input/output devices associated with a computer for interacting with a user of the terminal 101. In one embodiment, terminal 101 is a personal computer having a Pentium® class processor, a suitable memory, hard disk and user interface and a network interface compatible with the communications link 102.

As shown in FIG. 1, each terminal 101 is connected through communication link 102 and bus 109 to the match engine 105. A communications link 102 also directly connects the match engine 105 to the contract generator 103. In the disclosed embodiments, the match engine 105 includes a matching system, i.e. a system capable of receiving bids and offers and otherwise managing the execution of trades in a marketplace, such as those provided by Chicago Mercantile Exchange Inc., (CME Group) located in Chicago, Ill. However, the embodiments disclosed herein are applicable to any trading or futures market in the United States or elsewhere in the world, for example, the Chicago Board of Trade (CBOT), the Bolsa de Mercadorias e Futoros in Brazil (BMF), the London International Financial Futures Exchange, the New York Mercantile Exchange (NYMEX), the Kansas City Board of Trade (KCBT), MATIF (in Paris, France), the London Metal Exchange (LME), the Tokyo International Financial Futures Exchange, the Tokyo Commodity Exchange for Industry (TOCOM), the Meff Renta Variable (in Spain), the Dubai Mercantile Exchange (DME), and the Intercontinental Exchange (ICE).

The match engine 105 matches orders, including resting orders and new orders, electronically according to one or more trade matching algorithms, such as a first-in-first-served algorithm, an allocation algorithm, or a market maker priority algorithm. An “order” can be a bid or offer to purchase or a bid or offer to sell. In one embodiment, the match engine 105 is implemented as a software program that executes on a computer system capable of executing the match engine 105 and interfacing with the communications link 102. Alternatively, the match engine 105 may be implemented as a combination of hardware and software.

Although the match engine 105 and the contract generator 103 are illustrated as separate devices that are capable of being run on one or more computers, in alternative embodiments these systems and methods can also be integrated within a single device. The match engine 105 is further capable of operating in an automatic, semi-automatic or manual fashion.

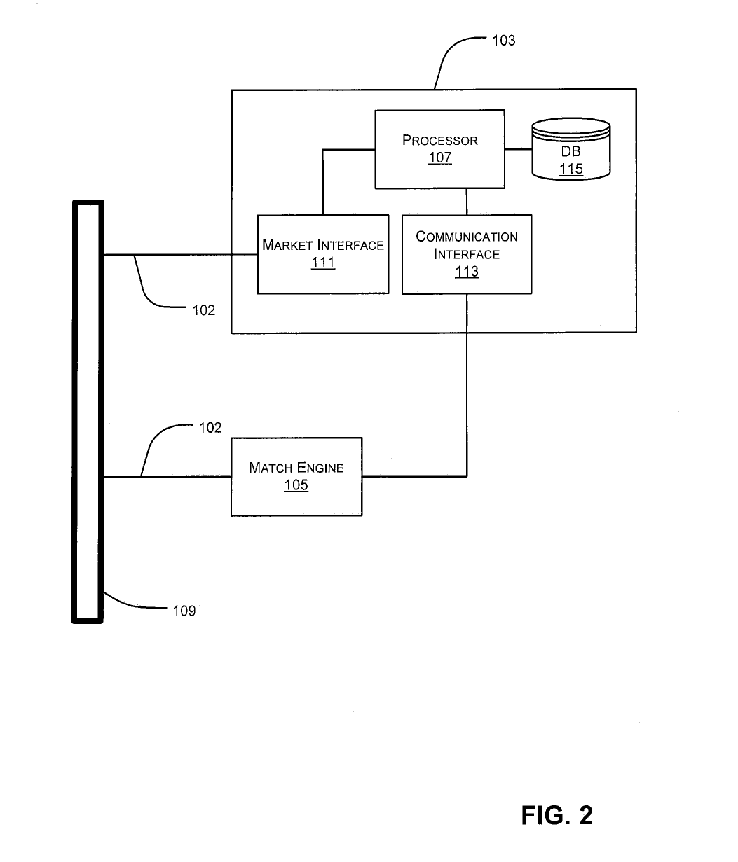

FIG. 2 illustrates a detailed view of the contract generator 103 of operable within the electronic trading system 100 shown in FIG. 1. Contract generator 103 includes a processor 107, a database 115, a market interface 111, and a communication interface 113.

Processor 107 may be any type of general purpose processor configured to define a sovereign debt based futures contract according to the first request and the second request using a rating, notional amount, coupon, coupon date, maturity or any other variable and/or factor typically utilized to define a bond.

Database 115 may be any conventional storage system, such as a hard disk or memory. Database 115 stores data regarding the contracts available in the associated exchange/match engine. Database 115 may also include market data information, expert opinion and financial quotes.

Market interface 111 includes the hardware and/or software components necessary to communicate with terminals 101 and communication link 102 and bus 109 to receive one or more orders from a market participant via one terminal 101 for a futures contract based on a sovereign debt instrument.

Communication interface 113 includes the hardware and/or software components necessary for the contract generator 103 to communicate with match engine 105. The match engine 105 receives the definition of the sovereign debt futures contract stored in database 115 through communication interface 113.

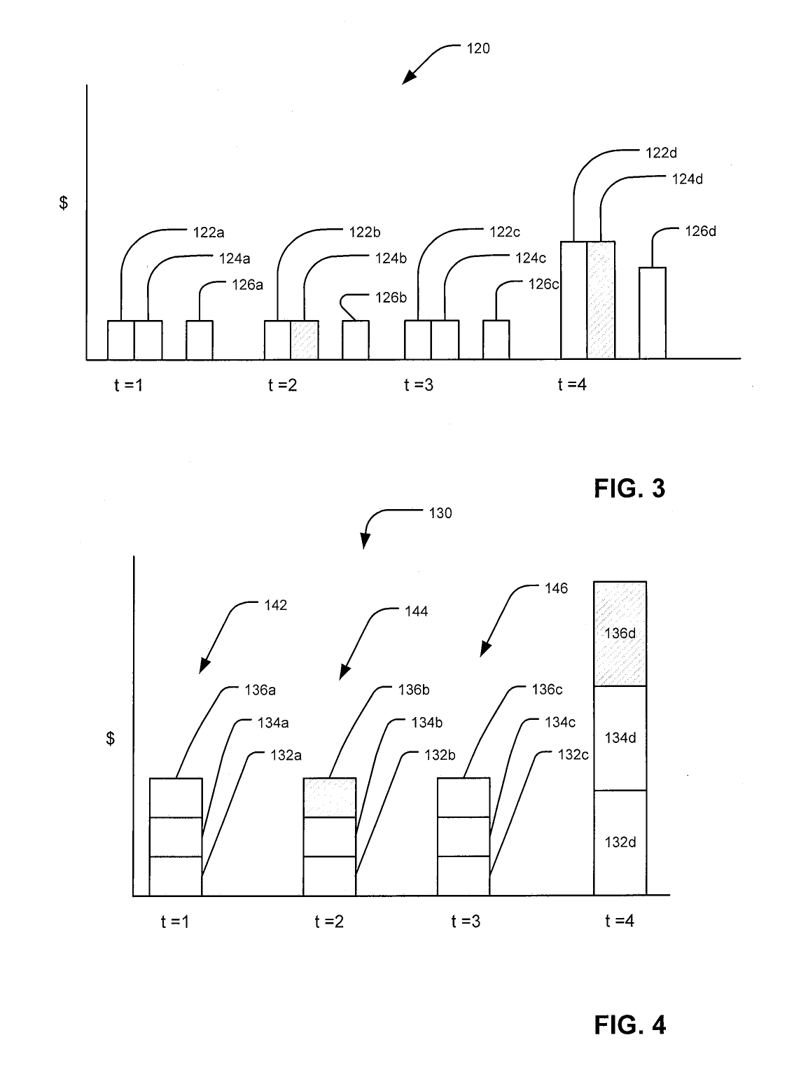

FIG. 3 illustrates a known bond offering that may be implemented by a local, state or federal government. Sovereign bonds are typically issued in the sovereign's own currency but may be issued in other currencies based on the credit risk associated with the sovereign, the sovereign's currency and other know credit and/or risk factors. In exchange for the loan (i.e., the purchase of the sovereign bond) the issuer agrees to make interest payments on the value of the sovereign bond as well as repay the loan amount on a maturity date. The interest rate that the issuer of the sovereign bond must pay is influenced by a variety of factors, such as, for example, current market interest rates, the length of the term and the creditworthiness of the issuer.

Sovereign bonds may be defined by a number of factors such as (a) a nominal or principle amount; (b) an issue price; (c) a maturity date; and (d) coupon. The nominal or principal amount is the value of the bond upon which interest is paid and which is repaid on the maturity date. The issue price is the amount the holder or buyer of the bond pays at issuance. The maturity date is the date on which the issuer has to repay the nominal amount. In other words, the maturity date is the date on which the sovereign debt or the loan to the sovereign must be repaid. The length or period of time until the maturity date is referred to as the term or tenor of the bond. Sovereign bonds or debt issued by the U.S. Treasury are grouped into three classes bond maturities: (i) short term bills with a maturity of a year or less; (ii) medium term notes with a maturity between one and ten years; and long term binds with a maturity greater than ten years. The coupon is the interest that the issuer pays to the bondholders. The interest is typically fixed throughout the period or term of the bond. In other embodiments, the interest can be varied over the period or term of the bond in conjunction with, for example, an index such as LIBOR.

Returning to FIG. 3, the chart 120 represents an exemplary sovereign bond issuance for three sovereign debt instruments 122, 124 and 126. The chart 120 shows the value or amount of the contract or coupon on the vertical axis and time periods 1 to 4 along the horizontal axis. Each of the exemplary sovereign debt instruments 122, 124 and 126 includes payments or coupons occurring at or around time period (t) 1 to 4. For example, sovereign debt instrument 122 includes coupon 122a at time period 1, coupon 122b at time period 2, coupon 122c at time period 3 and a lump sum or loan repayment 122d at the maturity time period 4. Each of the coupons a to d associated with sovereign debt instruments 122, 124 and 126 occur at different, but regularly occurring, intervals. The notional amount, maturity and interest rate may likewise vary between the sovereign debt instruments 122, 124 and 126. The variation and difference between the sovereign debt instruments 122, 124 and 126 occurs because each instrument is customized and/or individually negotiated by each of the issuers. The lack of standardization between the coupons, maturities and/or rates associated with the sovereign debt instruments 122, 124 and 126, results in a trading market with low liquidity.

FIG. 4 illustrates a chart 130 represents a sovereign bond issuance organized and configured according to the disclosure provided herein. In this exemplary embodiment, the three sovereign debt instruments 132, 134 and 136 are standardized to provide for common notional amounts, maturities, coupons and/or coupon dates. Thus, as shown in the chart 130, all of the coupons 132a, 134a and 136a may occur at time period 1. Similarly, the remaining coupons and lump sum payments (b to d) are aligned at the time period 2 to time period 4, respectively.

The grouped or standardized sovereign debt instruments 132, 134 and 136 and their associated coupons a to d may provide the basis for futures contracts that may be offered via the electronic trading system 100. For example, a sovereign debt futures contract 142 may include each of the coupons 132a, 134a and 136a at time period 1. Similarly, sovereign debt futures contracts 144 and 146 may be defined for standardized sovereign debt instruments 134 and 136, respectively.

The sovereign or other bonding issuing entity may utilize an underwriter to evaluate overall bond offering as well as the credit worthiness of the issuer. Based on the evaluation by the underwriter a credit rating or any other rating reflective of the risk associated with the bond offering may be assigned. An interest rate may further be associated with the issuer and/or the bond offering reflective of the risk associated therewith. The rating and/or the interest rate may utilized to indicate different, but related, aspects of the bond issuer and bond offering. For example, in one embodiment, the interest rate may reflect the repayment risk associated with a given bond offering while the rating may reflect the creditworthiness of the bond issuer itself.

Individual bonds and/or entire clusters of bond may, in turn, be grouped or bundled into debt investment groups based on the assigned rating and/or interest rate. In this way bonds or bond issuances with similar risks and/or creditworthiness may be organized and grouped. This commonality and grouping serves to increase the overall value and volume of bonds at any given rating and/or interest rate. In other words, this standardization and grouping serves to increase the liquidity of the sovereign debt bond market.

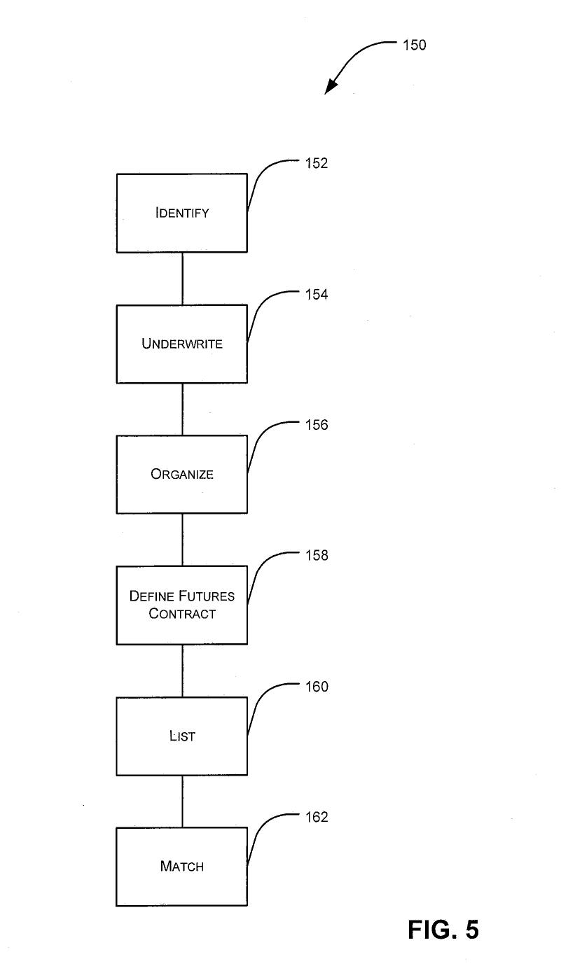

FIG. 5 is a flowchart illustrating a process and method 150 by which sovereign debt instruments may be listed and traded via the electronic trading system 100.

At step 152, the issuer or sovereign entity such as a state or federal government may identify a project requiring a bond offering for funding. For example, the project may be an infrastructure investment, short-term debt relief or any other governmental expenditure. At step 154, an underwriter or other financial entity such as a financial exchange may receive and evaluate financial parameters representative if the bond offering. The underwriter or other financial entity may analyze and determine the credit risk of the bond offering as well as the credit worthiness of the sovereign entity. The underwriter or other financial entity may identify or assign a rating and/or an initial or starting interest rate to the bond offering. The underwriter or other financial entity may further ensure that the terms such as the maturity dates, coupon dates, notional amounts, etc. are standardized to increase liquidity in the sovereign debt market. At step 156, the underwriter and/or the exchange may organize the debt instruments according to their maturity and rating to define one or more related debt instrument groups. At step 158, a sovereign debt future contract may be defined for each of the standardized coupons and payments within the one or more debt instrument groups. At step 160, the sovereign debt future contract may be listed on the electronic trading system 100. At step 162, the listed sovereign debt future contract may be matched by the match engine 105 with one or more received and/or resting orders.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A method of trading sovereign debt on an electronic trading exchange, the method comprising:
receiving financial parameters associated with a plurality of debt instruments offered by a sovereign entity, wherein the financial parameters include at least a maturity, a coupon and a rating;
organizing the plurality of debt instruments according to their maturity and rating to define one or more debt instrument groups;
defining a standardized financial product associated with each coupon in the one or more debt instrument groups;
listing each standardized financial product on the an electronic trading exchange; and
matching at least one of the standardized financial products with an order received at the electronic trading exchange.

2. The method of claim 1, wherein each of the coupons in the one or more debt instrument groups are aligned.

3. The method of claim 1, wherein the aligned coupon within the one or more debt instruments groups are aligned based on time.

4. The method of claim 1, wherein the financial parameters include a notional amount.

5. The method of claim 1, wherein organizing the plurality of debt instruments further includes organizing the plurality of debt instruments according to their notional amounts.

6. The method of claim 1, wherein the rating is a financial rating established by an underwriting entity.

7. A method of trading sovereign debt on an electronic trading exchange, the method comprising:
receiving a first order for a standardized financial product, wherein the standardized financial product is based on at least two sovereign debt instruments, and wherein the at least two debt instruments are organized based on a maturity and a coupon;
receiving a second order for the standardized financial product;
matching the first order and the second order with the standardized financial instrument;
executing a trade based on the matched first and second orders, wherein the first order represents a long position in the standardized financial product and the second order represents a short position in the standardized financial product; and
outputting the trade from the electronic trading exchange.

8. The method of claim 7, wherein each of the coupons associated with the at least two debt instruments is aligned.

9. The method of claim 8, wherein the aligned coupons within the one or more debt instruments groups are aligned based on time.

10. The method of claim 7, wherein the financial parameters include a notional amount.

11. The method of claim 7 further comprising:
receiving financial parameters associated with the at least two sovereign debt instruments offered by a sovereign entity, wherein the financial parameters include at least a maturity, a coupon and a rating.

12. The method of claim 11, wherein the rating is a financial rating established by an underwriting entity.

13. The method of claim 7 further comprising:
organizing the at least two sovereign debt instruments according to a maturity and a rating.

14. The method of claim 7, wherein the standardized financial product associated with at least one coupon related to the at least two sovereign debt instruments.
